(19) United States
(12) Patent Application Publication
(10) Pub. No.: US 2020/0389512 A1
(43) Pub. Date: Dec. 10, 2020

(54) PROVIDING PREVIEWS FOR UNIFORM RESOURCE LOCATORS

(71) Applicant: Microsoft Technology Licensing, LLC, Redmond, WA (US)

(72) Inventors: Siddharth UPPAL, Bothell, WA (US); Pedro Dantas DEROSE, Redmond, WA (US)

(21) Appl. No.: 16/431,558

(22) Filed: Jun. 4, 2019

(51) Int. Cl. H04L 29/08; G06F 16/955; G06Q 30/06; H04L 29/06

(52) U.S. Cl. CPC H04L 67/02; H04L 67/42; G06Q 30/0641; G06F 16/9566

(57) ABSTRACT

Aiding preview providers in providing previews of uniform resource locators to client computing systems in which the uniform resource locators are represented. Upon determining that a uniform resource locator is represented in a client computing system, a preview provider (amongst multiple preview providers) is selected based on a structure of the uniform resource locator. Then, communication is facilitated between the selected preview provider and the client computing system. Within the communication, the preview provider can provide a preview corresponding to the uniform resource locator to the client computing system. This type of mediation may occur between any number of client computing systems and any number of preview providers.

### BACKGROUND

A uniform resource locator (or URL) is a character string that is used to reference a resource available on a computer network—such as the Internet. Example resources may be a web page, file, account, database, and so forth. A uniform resource locator is often termed a “web address”. The uniform resource locator resolves to a mechanism for retrieving the resource from the computer network. For instance, a Domain Name Server (DNS) server may be used to resolve the uniform resource locator to an Internet Protocol (IP) address. The Internet Protocol may then be used to access the resource using the IP address.

A uniform resource locator (or a visualization associated with the uniform resource locator) may be hyperlinked so that a user may simply select the uniform resource locator (or its visualization) to thereby trigger resolving the uniform resource locator, and using the resulting access mechanism to access the corresponding resource. Some applications may also provide a preview of the resource so that the user has some idea of what the resource is prior to selecting the hyperlink. For instance, a uniform resource locator may be posted in a social media page, a chat window, a document, an e-mail, or the like, resulting in a preview of the underlying resource being automatically shown to the Conventionally, the mechanism for generating the preview is predetermined based on the type of resource being accessed. For instance, if the resource is a web page, the title of the web page might be extracted and used to populate one predetermined portion of the preview. Similarly, other predetermined parts of the web page may be accessed and populated into other predetermined portions of the preview.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to aiding preview providers in providing previews of uniform resource locators to client computing systems in which the uniform resource locators are represented. Upon determining that a uniform resource locator is represented in a client computing system, a preview provider (amongst multiple preview providers) is selected based on a structure of the uniform resource locator. Then, communication is facilitated between the selected preview provider and the client computing system. Within the communication, the preview provider can provide a preview corresponding to the uniform resource locator to the client computing system in which the uniform resource locator is represented.

This type of mediation may occur between any number of client computing systems and any number of preview providers. Thus, rather than have predetermined ways of generating previews, the user of the client computing system may associate with a favorite set of preview providers to obtain more meaningful and richer previews for that user. Similarly, preview providers are given a platform to expose their services to a variety of users.

In some embodiments, the preview may even be provided with a control that permits the user to take some action based on the preview, other than merely accessing the resource. For instance, the user might have a sign-in control within the preview itself that allows the user to sign into a resource associated with the uniform resource locator. As another example, the user might have a buy now control allowing the user to buy something associated with the uniform resource locator. As yet another example, the user might change some state of the resource associated with the uniform resource locator.

Thus, the principles described herein advance the technical art of generating previews for uniform resource locators. This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an environment in which the principles described herein may be employed, and which includes a server computing system which mediates between multiple preview providers that provides previews for uniform resource locators and multiple client computing systems in which uniform resource locators may be represented over time;

FIG. 2 illustrates a flowchart of a method for aiding preview providers providing previews of uniform resource locators to client computing systems in which the uniform resource locators are represented, in accordance with the principles described herein;

FIG. 3 illustrates a mapping data structure that correlates uniform resource locator patterns to preview providers;

FIG. 4 illustrates an example method that represents an example of the method of FIG. 2;

FIG. 5 illustrates a flowchart of a method for ensuring that the user consents to the preview provider providing a preview;

FIG. 6 illustrates an example mapping data structure that maps users to preview providers;

FIG. 7 illustrates a preview that includes a control;

FIG. 8 illustrates an environment in which there is the preview of FIG. 7, which includes a control that may be interfaced with by the user; and

FIG. 9 illustrates an example computer system in which the principle described herein may be employed.

### DETAILED DESCRIPTION

At least some embodiments described herein relate to aiding preview providers in providing previews of uniform resource locators to client computing systems in which the uniform resource locators are represented. Upon determining that a uniform resource locator is represented in a client computing system, a preview provider (amongst multiple preview providers) is selected based on a structure of the uniform resource locator. Then, communication is facilitated between the selected preview provider and the client computing system. Within the communication, the preview provider can provide a preview corresponding to the uniform resource locator to the client computing system in which the uniform resource locator is represented.

This type of mediation may occur between any number of client computing systems and any number of preview providers. Thus, rather than have predetermined ways of generating previews, the user of the client computing system may associate with a favorite set of preview providers to obtain more meaningful and richer previews for that user. Similarly, preview providers are given a platform to expose their services to a variety of users.

In some embodiments, the preview may even be provided with a control that permits the user to take some action based on the preview, other than merely accessing the resource. For instance, the user might have a sign-in control within the preview itself that allows the user to sign into a resource associated with the uniform resource locator. As another example, the user might have a buy now control allowing the user to buy something associated with the uniform resource locator. As yet another example, the user might change some state of the resource associated with the uniform resource locator.

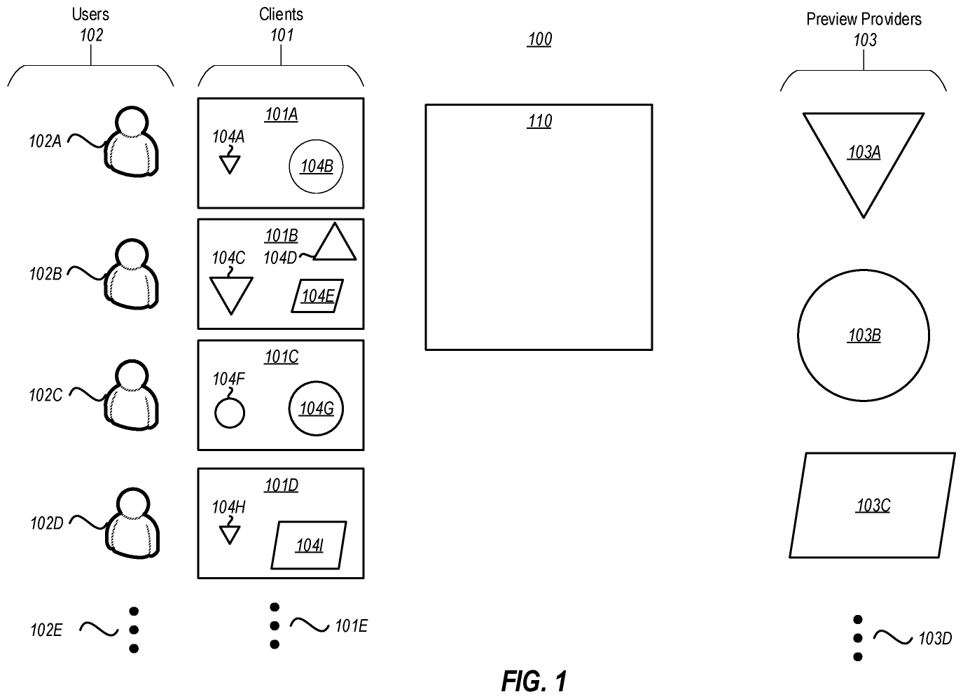

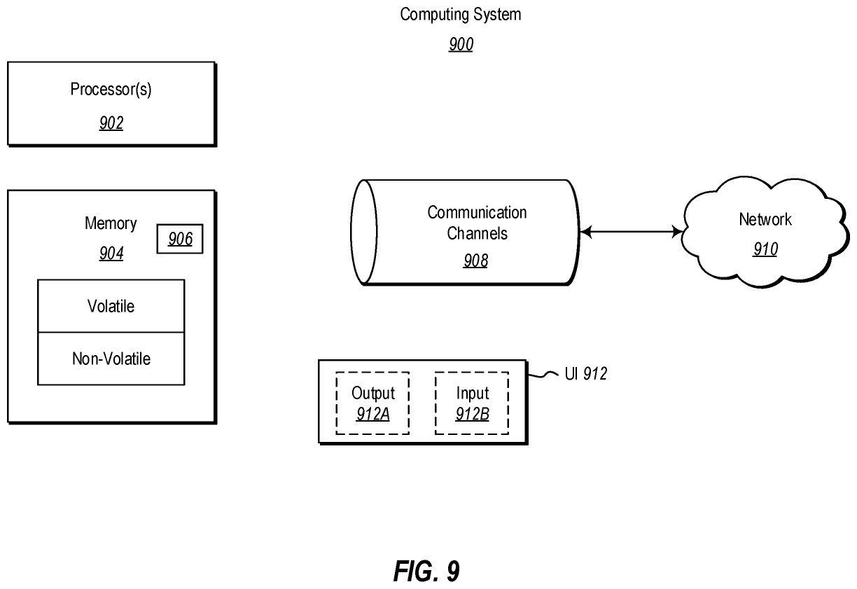

FIG. 1 illustrates an environment 100 in which the principles described herein may be employed. The environment 100 includes multiple client computing systems 101 and associated users 102. In the illustrated example, there are four client computing systems 101A through 101D illustrated. However, the ellipsis 101E represents that the client computing systems 101 within the environment 100 may include any number of client computing systems 101, and the number and identity of the client computing systems may change over time. Each client computing system 101 may be structured as described below for the computing system 900 of FIG. 9.

In the illustrated example, there are four users 102A through 102D corresponding to each client computing system 101A through 101D, respectively. However, the ellipsis 102E represents that the number and identity of users 102 of those client computing systems 101 may likewise change over time, and further that a single client computing system may potentially have multiple users and that the user(s) of a given client computing system may also change over time.

The environment 100 also includes multiple preview providers 103. Each preview provider 103 may provide previews associated with particular uniform resource locators. The preview provides the user with a visual representation of a portion of the content of the resource represented by the uniform resource locator. For instance, if the uniform resource locator is a news web page, the preview might identify the news outlet, and perhaps provide one or a few headlines. If the uniform resource locator is a page of an e-commerce site associated with a particular product, the preview might show the product, and some basic information about the product (and potentially provide a control allowing the user to buy the product). If the uniform resource locator is a software developer collaboration site, the preview might show some visualization of the collaboration site, identify unresolved bugs, and potentially offer a control to close (i.e., identify as resolved) a particular software bug.

Each preview provider 103 may be structured as described below for the computing system 900 of FIG. 9. In the example of FIG. 1, there are three preview providers 103A through 103C illustrated. However, the ellipsis 103D represents that there may be any number of preview providers 103 within the environment 100, and that the number and identity of the preview providers may change over time.

A variety of uniform resource locators may be represented in the client computing systems 101. For instance, a user might type or paste the uniform resource locator into a respective application of a client computing system, or a user might receive an electronic message or open an electronic document that contains the uniform resource locator.

In the illustrated example, uniform resource locators 104A and 104B are represented on client computing system 101A, uniform resource locators 104C through 104E are represented on client computing system 101B, uniform resource locators 104F and 104G are represented on client computing system 101C, and uniform resource locators 104H and 104I are represented on client computing system 101D. The uniform resource locators 104A through 104I will often be referred to herein collectively as the uniform resource locators 104. Although the uniform resource locators 104 are illustrated as being represented on the client computing systems 101 at the same time, the uniform resource locators 104 may be represented on their respective client computing systems one at a time at perhaps at different times.

Uniform resource locators are each a string of characters. Often uniform resource locators might have a common pattern, even though the uniform resource locators are different. For instance, different uniform resource locators may nonetheless have the same domain name (e.g., “contoso.com”). In FIG. 1, uniform resource locators that have a common pattern are represented by the uniform resource locators having a same shape. However, different uniform resource locators, though having the same common pattern, are represented by the uniform resource locators having a same shape, but with a different size.

For instance, in the example of FIG. 1, uniform resource locators 104A, 104C and 104H are all represented by a downward-pointing triangle, representing that these uniform resource locators follow a same first pattern. However, the uniform resource locators 104A and 104H are shown as having a same-sized downward-pointing triangle, representing that the uniform resource locators 104A and 104H are the same. In contrast, the uniform resource locator 104C is shown larger in size, representing that the uniform resource locator 104C, though following the same first pattern, is different than the uniform resource locators 104A and 104H.

Continuing the example, the uniform resource locators 104B, 104F and 104G follow a second pattern, as represented by each being represented by a circle. However, while the uniform resource locators 104B and 104G are the same, the uniform resource locator 104F is different. Furthermore, the uniform resource locators 104E and 104I follow a third pattern, as represented by each being represented by a parallelogram, but the uniform resource locators 104E and 104I do still differ from each other. Finally, the uniform resource locator 104D follows a fourth pattern, as represented by an upward-pointing triangle.

Each preview provider 103 is configured to provide previews for uniform resource locators that follow a particular pattern. For instance, preview provider 103A is configured to provide previews for uniform resource locators that follow the first pattern. Accordingly, the preview provider 103A might provide previews for uniform resource locators 104A, 104C and 104H that follow the first pattern. Thus, the preview provider 103A (like the uniform resource locators 104A, 104C and 104H) is represented as a downward-facing triangle. Similarly, the preview provider 103B is configured to provide previews for uniform resource locators (such as uniform resource locators 104B, 104F and 104G) that follow the second pattern, and is thus similarly represented by a circle. Also, the preview provider 103C is configured to provide previews for uniform resource locators (such as uniform resource locators 104E and 104I) that follow the third pattern, and is thus similarly represented by a parallelogram. There is no preview provider that is configured to provide a preview for uniform resource locators (such as uniform resource locator 104D) that follow the fourth pattern, and thus there is no preview provider amongst the preview providers 103 that is shaped as an upward-pointing triangle.

A server computing system 110 mediates between the preview providers 103 and the client computing systems 101. More specifically, the server computing system 110 mediates by aiding the preview providers 103 providing previews of uniform resource locators to respective client computing systems 101 in which the uniform resource locators are represented. The server computing system 110 may be structured as described below for the computing system 900 of FIG. 9.

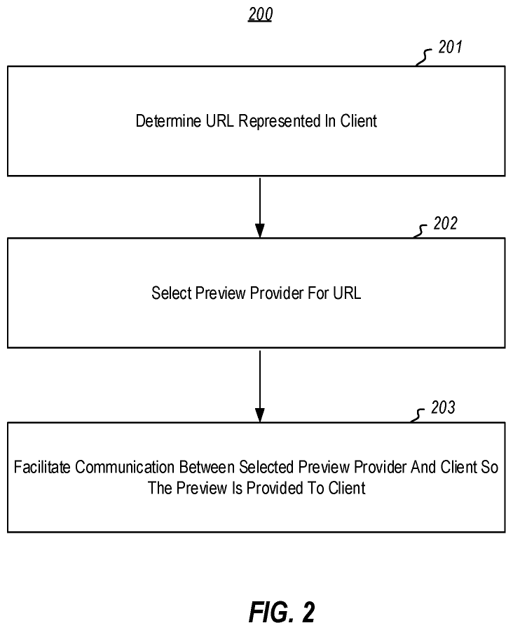

FIG. 2 illustrates a flowchart of a method 200 for aiding preview providers providing previews of uniform resource locators to client computing systems in which the uniform resource locators are represented. As an example, the method 200 may be performed by the server computing system 110 of FIG. 1. Accordingly, the method 200 of FIG. 2 will now be described with frequent reference to the environment 100 of FIG. 1. For instance, if the server computing system 110 is the computing system 900 of FIG. 9, the method 200 may be performed by the computing system 900 in response to one or more processors (e.g., the at least one hardware processing unit 902) executing computer-executable instructions that are on one or more computer-readable media (e.g., the memory 904). Those computer-executable instructions may be structured such that, when executed by the one or more processors, the computing system is caused to perform the method 200.

The method 200 begins upon determining that a uniform resource locator is represented in a client computing system (act 201). For instance, in an example referred to herein as the “subject example” with reference to FIG. 1, the server computing system 110 determines that the uniform resource locator 104A is represented in the client computing system 101A. For instance, the user 102A might have viewed a data structure (e.g., a document, a window, an electronic communication, a web page, or the like) that includes the uniform resource locator 104A. The user 102A might also have typed or pasted the uniform resource locator 104A into such a data structure. In the subject example of FIG. 1, the method 200 would then continue to cause a preview of the uniform resource locator 104A to be displayed to the user 102A of the client computing system 101A. The preview will give the user some idea of the content of the resource represented by the uniform resource locator 104A. For instance, portions of the resource might be used to populate (after potentially some filtering) portions of the preview.

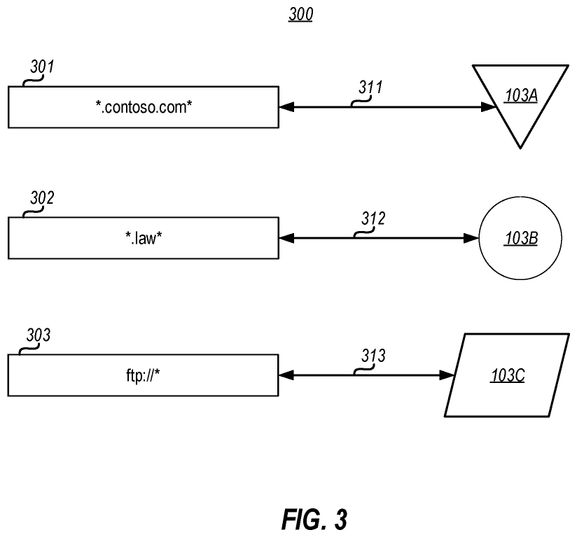

Returning to the method 200 of FIG. 2, based on the structure of the uniform resource locator, the server computing system 110 selects a preview provider from amongst the multiple preview providers (act 202). As an example, this may be performed by comparing the uniform resource locator against mappings of uniform resource locators and corresponding preview providers. For instance, FIG. 3 illustrates a mapping data structure 300 that correlates (as represented by bi-directional arrow 311) uniform resource locator pattern 301 to preview provider 103A, uniform resource locator pattern 302 to preview provider 103B as represented by bi-directional arrow 312, and uniform resource locator pattern 303 to preview provider 103C as represented by bi-directional arrow 313.

For instance, the uniform resource locator pattern 301 might be “*.contoso.com*” (where “*” is a wildcard and may represent any string of any length, and may include a null string), representing an example first pattern. Thus, “www.contoso.com/dashboard/review.html”, “http://www.upgrade.contoso.com”, and “www.myview.contoso.com/myaccount.html” would each be a uniform resource locator that matches the uniform resource locator pattern 301, even though these uniform resource locators are different than each other. As a further example, the uniform resource locator pattern 302 might be “*.law*” (representing an example second pattern) and thus any uniform resource locator having the “Jaw” extension would match this uniform resource locator pattern 302. As a further example, the uniform resource locator pattern 303 might be “ftp://*” (representing an example third pattern) and thus any file transfer protocol uniform resource locator would match this uniform resource locator pattern 303.

Of course, these uniform resource locator patterns 301 through 303 are just examples, as the principles described herein may apply to any uniform resource locator pattern, however broad, or however narrow, and however expressed. Furthermore, while there are only three uniform resource locator patterns in the example, the principles described herein may extend to embodiments in which the number of uniform resource patterns are innumerable.

In the subject example, suppose that the uniform resource locator 104A is “www.contoso.com/dashboard/review.html”. Accordingly, the server computing system 110 selects the preview provider 103A as providing the corresponding preview for the uniform resource locator 104A (act 202).

Returning to FIG. 2, in response to the selection of the preview provider based on the structure of the uniform resource locator (act 202), the server computing system then facilitates communication (act 203) between the client computing system in which the uniform resource locator is represented and the preview provider that was selected based on the structure of that uniform resource locator. The purpose of this communication is to enable the preview provider that was selected based on the structure of the uniform resource locator to provide a preview corresponding to the uniform resource locator to the client computing system in which the uniform resource locator is represented. In the subject example of FIG. 1 in which the uniform resource locator 104A is represented in the client computing system 101A, the server computing system 110 facilitates communication between the selected preview provider 103A and the client computing system 101A. This is so that the selected preview provider 103A provides a preview for the uniform resource locator 104A to the client computing system 101A. The client computing system 101A may then show the preview of the uniform resource locator 104A to the user 102A.

The method 200 may be repeated each time the server computing system 110 determines that a uniform resource locator has been represented within one of the client computing systems 101. For instance, upon determining that the uniform resource locator 104B has been represented in the client computing system 101A (act 201), the server computing system 110 may select the preview provider 103B (act 202), and facilitate communication between the preview provider 103B and the client computing system 101A so that the preview provider 103B can provide a preview associated with the uniform resource locator 104B to the client computing system 101A (act 203). This allows the client computing system 101A to display that preview to the user 102A. As an example, this uniform resource locator 104B might have been “www.mylawoffice.law”, which matches the example second pattern 302 of FIG. 3.

Here, the preview provider (preview provider 103A) selected by the server computing system 110 in response to determining that the uniform resource locator 104A was represented in the client computing system 101A is different than the preview provider (preview provider 103B) selected by the server computing system 110 in response to determining that the uniform resource locator 104B was represented in the same client computing system 101A. Thus, a single client computing system may be provided with previews from a variety of preview providers.

Continuing, the method 200 may again be performed upon the server computing system 110 determining that the uniform resource locator 104C was represented in the client computing system 101B (act 201). In that case, the uniform resource locator 104C matches the same first pattern as the uniform resource locator 104A that was represented in the client computing system 101A, even though the uniform resource locator 104A is different than the uniform resource locator 104C. As an example, the uniform resource locator 104C might be “www.contoso.com/email/userB/main.html”. Accordingly, the server computing system 110 selects the preview provider 103A. Thus, the same preview provider (e.g., preview provider 103A) may provide previews for uniform resource locators matching a particular pattern to a variety of different client computing systems.

The method 200 may also be performed when the server computing system 110 determines that the uniform resource locator 104E is represented in client computing system 101B (act 201), resulting in the preview provider 103C being matched to that uniform resource locator 104E (act 202), and the server computing system 110 facilitating communications (act 203) so that the preview provider 103C provides a preview for that uniform resource locator 104E to the client computing system 101B. Similarly, when the server computing system 110 determines that the uniform resource locator 104F (and uniform resource locator 104G) is represented in client computing system 101C, the server computing system 110 selects the preview provider 103B and mediates the preview provider 103B providing a preview of the uniform resource locator 104F (and a preview of the uniform resource locator 104G) to the client computing system 101C. Likewise, when the uniform resource locator 104H is represented in the client computing system 101D, the server computing system 110 operates such that the preview provider 103A provides a preview of the uniform resource locator 104H to the client computing system 101D. Completing the example, when the uniform resource locator 104I is represented in the client computing system 101D, the server computing system 110 operates such that the preview provider 103C provides a preview of the uniform resource locator 104I to the client computing system 101D.

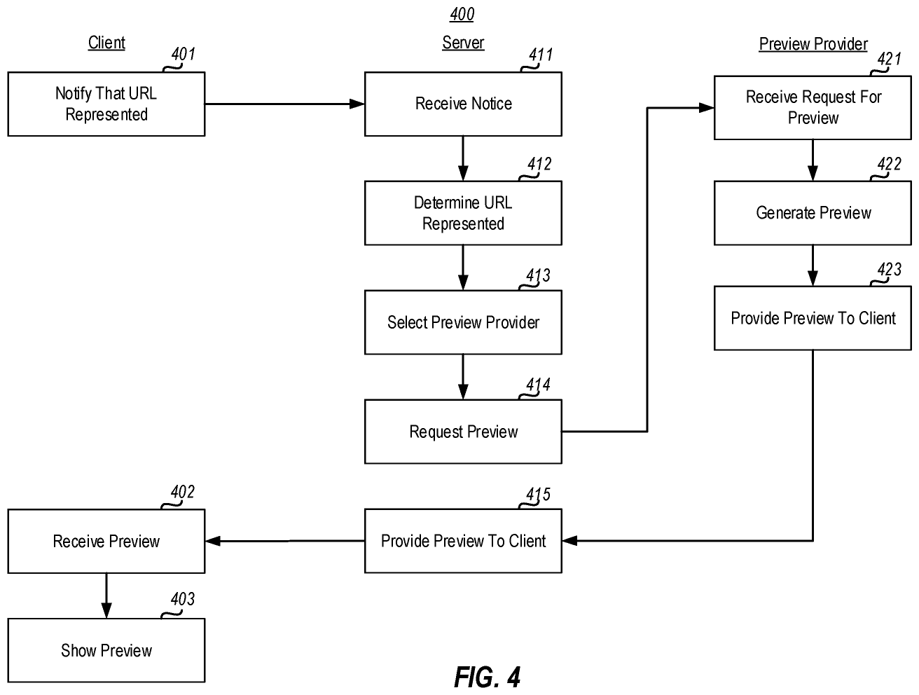

FIG. 4 illustrates an example method 400 that represents an example of the method 200 of FIG. 2. Some of the acts performed in the method 400 are performed by the client computing system (e.g., client computing system 101A in the subject example), and are thus represented in the left column under the heading “Client”. Others of the acts are performed by the server computing system (e.g., server computing system 110 of FIG. 1), and thus are represented in the middle column under the heading “Server”. Yet others of the acts are performed by the selected preview provider (e.g., preview provider 103A of FIG. 1 in the subject example), and thus are presented in the right column under the heading “Preview Provider”.

In the method 400, the client computing system notifies the server computing system that a uniform resource locator is represented in the client computing system (act 401). This notification is made at a time when it would be appropriate for a preview of that uniform resource locator to be presented to a user. For instance, the user might have hovered a pointer over a particular uniform resource locator, or hovered over an object associated with that uniform resource locator. As another example, a user might have scrolled within a document to expose a uniform resource locator (or an object associated with that uniform resource locator) that appears in that document. As yet another example, a user might have received a chat or instant message that includes the uniform resource locator.

This notification is then received by the server computing system (act 411), allowing the server computing system to determine that the uniform resource locator is represented in the client computing system (act 412). Acts 411 and 412 represent an example of a way of performing act 201 of FIG. 2. The server computing system then selects the preview provider (act 413), which is an example of the act 202 of FIG. 2. The remaining portions of the method 400 represent an example way in which the server computing system may facilitate communication between the selected preview provider and the client computing system (act 203).

Specifically, the server computing system requests that the selected preview provider provide a preview corresponding to the uniform resource locator (act 414). Alternatively, the server computing system could instruct the client computing system to make the request of the preview provider. In either case, the selected preview provider receives the request (act 421) which may include the uniform resource locator. The selected preview provider then generates the requested preview (act 422), and provides the requested preview to the client computing system (act 423). In one embodiment, the selected preview provider does this by sending the preview directly to the client computing system. In another embodiment, the selected preview provider does this by sending the preview to the server computing system, which receives the preview, and provides the preview (act 415) to the client computing system. Either way, the client computing system receives the preview (act 402). This allows the client computing system to show the preview to its user (act 403).

In one embodiment, this facilitating of communication (act 203) further ensures that the user of the client computing system has consented to the preview provider providing previews. This allows the user to control whether preview providers can provide previews to the client computing system generally, and for any given pattern of uniform resource locators. Thus, the user may pick and choose which preview provider provides previews that are most helpful and meaningful to that user for a given category of uniform resource locators. Furthermore, preview providers that provide previews with the highest perception of quality, and that appeal to a broader spectrum of users, tend to get used more. Thus, previews become of higher quality and of richer content.

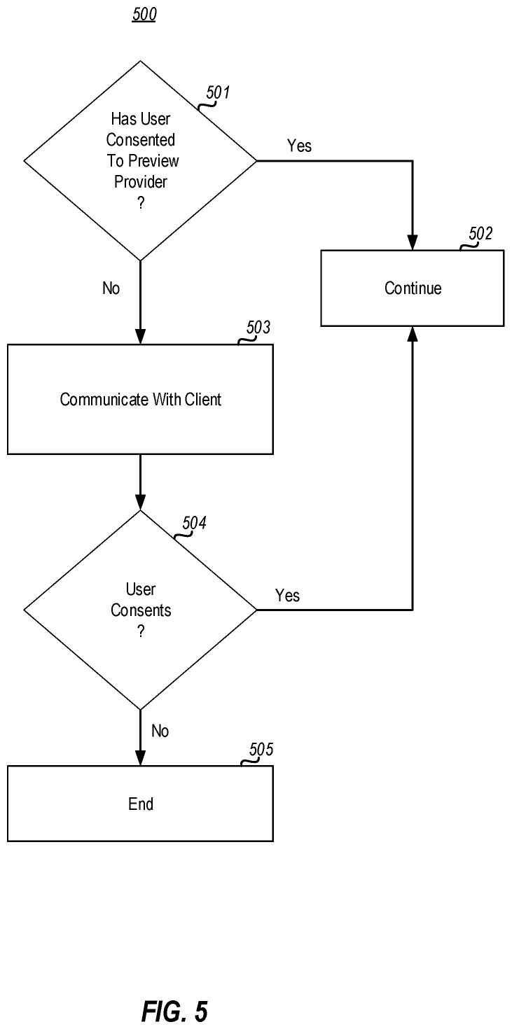

FIG. 5 illustrates a flowchart of a method 500 for ensuring that the user consents to the preview provider providing a preview. In one example, the method 500 may be performed prior to the server computing system requesting the preview from the selected preview provider (prior to act 414 in FIG. 4).

The method 500 includes determining whether a user of the client computing system has consented to association with the selected preview provider (decision block 501). If there is consent (“Yes” in decision block 501), then the process continues (act 502) by, for instance, proceeding to act 414 in FIG. 4, and requesting the preview from the selected preview provider.

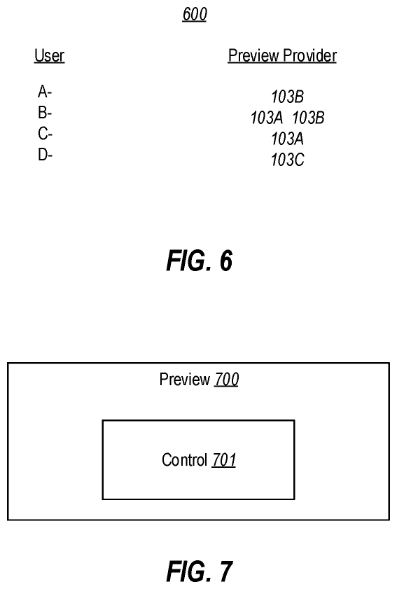

The determination regarding consent may be made by conferring a mapping between users and preview providers. The corresponding preview providers may be preview providers that the user has already consented to, or for some reason it is otherwise appropriate for the preview provider to provide a preview for matching uniform resource locators to that user. For instance, FIG. 6 illustrates an example mapping data structure 600 that maps users to preview providers.

In the example of FIG. 6, user A through D (e.g., corresponding to users 102A through 102D of FIG. 1) are mapped to corresponding preview providers. Per the example mapping data structure, the user 102A has consented to previews from the preview provider 103B (but not from the preview providers 103A and 103C). Furthermore, the user 102B has consented to previews from the preview providers 103A and 103B (but not from the preview provider 103C). Also, user 102C has consented to previews from the preview provider 103A (but not from the preview providers 103B and 103C). Finally, user 102D has consented to previews from the preview provider 103C (but not from the preview providers 103A and 103B).

In the subject example of FIG. 1, in which the uniform resource locator 104A has been represented in the client computing system 101A, and in which the preview provider 103A is selected, the mapping data structure 600 may be referenced to determine that the user 102A (i.e., user A) has only consented to association with preview provider 103B, and not the selected preview provider 103A (No in decision block 501). In this case (“No” in decision block 501), the server computing system communicates with the client computing system (act 503) to thereby determine whether the user now consents (decision block 504). In this case, the user might be presented with the option to add a particular preview provider. In so doing, the user might be given characteristics of the preview provider, what the preview provider emphasizes in the preview, and so forth.

If the user chooses not to consent (“No” in decision block 504), the method 500 ends (and the methods 200 and 400 also end without a preview being provided from the selected preview provider). If the user chooses to consent (“Yes” in decision block 504), the preview provider may be added to the mapping data structure 600 for that user, and the method 500 thereafter continues (act 502).

In the example of FIG. 1, note that there is one preview provider corresponding to each of three patterns of uniform resource locators. In some embodiments, the patterns may actually overlap. For instance, “ftp://contoso.com” satisfies the example first pattern (because it contains “contoso.com”) as well as the example third pattern (because it contains “ftp://”). In this case, the preview provider selection logic may have prioritization to help resolve the ambiguity of which preview provider to select. Alternatively, or in addition, the user may be queried to resolve the ambiguity. In some cases, there may be multiple (or even numerous) preview providers that provide previews for uniform resource locators of the same category or pattern. In this case, the user has a large selection to choose from in determining which type of preview to receive given uniform resource locators of that pattern.

In some embodiments, the server computing system 110 may itself generate a preview based on a pre-defined template and provide that pre-defined template to the client computing system. Generating previews according to a pre-defined template is the conventional way that previews are generated.

The server computing system might, for instance, provide this generated preview if there is not a preview provider selected based on the structure of the uniform resource locator. For instance, there is no corresponding preview provider 103 that can generate a preview for the uniform resource locator 104D, since this uniform resource locator does not match any of the first, second, or third patterns. As another example, the server computing system might provide the generated preview if the user does not consent to the selected preview provider (“No” in decision block 504), so at least some kind of preview is rendered for the user. As yet another example, the preview generated by the server computing system based on the pre-defined template may be provided even if a preview provider later provides a preview for that uniform resource locator. This permits some kind of preview to be shown prior to a richer preview being shown. Thus, the user may view a preview faster, even if that preview is not as high a quality for the user, even if that preview is replaced after some latency.

In one embodiment, the preview provided includes a control that a user of the client computing system may interface with. For instance, FIG. 7 symbolically illustrates a preview 700, which includes a control 701. As an example, the control 701 may be a purchase control that the user may interface with in order to make a purchase using a resource corresponding to the uniform resource locator. For instance, if the web site offers a particular product for sale, the control might allow the user to purchase that product in one click. Alternatively, the control 701 may be a state change control that the user may interface with in order to change a state of a resource corresponding to the uniform resource locator. For instance, if the resource is a collaborative workspace where developers work together on code, the control might allow a user to close a portion of work that has been completed (e.g., close a bug as having been resolved). As another example, the control 701 might be a sign-in control that the user may interface with in order to sign into a resource (e.g., a web page, a database, a server, or any other resource) corresponding to the uniform resource locator.

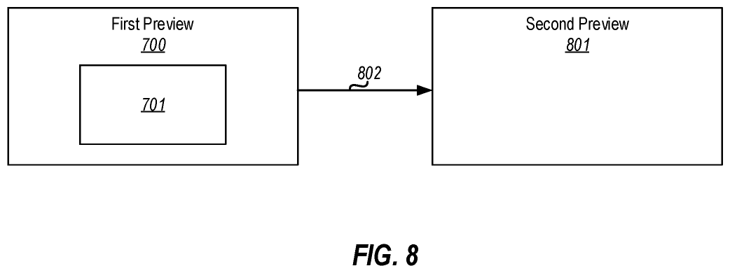

In one embodiment, the preview displayed is a first preview corresponding to the resource locator. That preview might have a control that causes a second preview to be manifested to the user. For instance, FIG. 8 illustrates an environment 800 in which there is the preview 700 of FIG. 7, which includes the control 701. When the user interfaces with the control 701, a second preview 801 appears (as represented by arrow 802). Though not shown in FIG. 8, the second preview might also have a control that, when interfaced with, causes yet another preview to be shown, and so forth.

The process represented by arrow 802 may be a repeat of the method 200, or at least a repeat of facilitating communication between the selected preview provider and the client computing system (act 203). For instance, in response to determining that the user has interfaced with the sign-in control, the server computing system facilitates communication between the client computing system in which the uniform resource locator is represented and the preview provider that was selected based on the structure of the uniform resource locator. This is so that the selected preview provider can then provide a second preview corresponding to the uniform resource locator to the client computing system in which the uniform resource locator is represented. For instance, if the control 701 within the first preview 700 was a sign-in control for signing into a resource corresponding to the uniform resource locator, the second preview 801 may include content accessible to the user only after signing into the resource.

As mentioned above, many of the elements may be structured as the computing system 900 of FIG. 9. Furthermore, actions described above may be performed by executable components, such as the executable component 906 of the computing system 900. Accordingly, a computing system 900 will now be described with respect to FIG. 9.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 9, in its most basic configuration, a computing system 900 typically includes at least one hardware processing unit 902 and memory 904. The memory 904 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 900 has thereon multiple structures often referred to as an “executable component”. For instance, the memory 904 of the computing system 900 is illustrated as including executable component 906. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Thus, once on of ordinary skill in the art understands the function to be performed, one of ordinary skill in the art will understand structures that can be used to perform that function.

Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example categories of structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, once one of ordinary skill in the art knows the function to be performed, the term “executable component” will reference a structure that is well understood by those of ordinary skill in the art of computing as a structured that may be implemented in software, hardware, or a combination. In this description, the term “component” may also be used. As used in this description and in the case, this term (regardless of whether the term is modified with one or more modifiers) is also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 904 of the computing system 900. Computing system 900 may also contain communication channels 908 that allow the computing system 900 to communicate with other computing systems over, for example, network 910.

While not all computing systems require a user interface, in some embodiments, the computing system 900 includes a user interface 912 for use in interfacing with a user. The user interface 912 may include output mechanisms 912A as well as input mechanisms 912B. The principles described herein are not limited to the precise output mechanisms 912A or input mechanisms 912B as such will depend on the nature of the device. However, output mechanisms 912A might include, for instance, speakers, displays, tactile output, holograms, virtual reality, and so forth. Examples of input mechanisms 912B might include, for instance, microphones, touchscreens, holograms, virtual reality, cameras, keyboards, mouse or other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media include RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or components and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RANI within a network interface component (e.g., a “NIC”), and then eventually transferred to computing system RANI and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program components may be located in both local and remote memory storage devices.

Those skilled in the art will also appreciate that the invention may be practiced in a cloud computing environment, which is supported by one or more datacenters or portions thereof. Cloud computing environments may be distributed, although this is not required. When distributed, cloud computing environments may be distributed internationally within an organization and/or have components possessed across multiple nations.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand, self-service, broad network access, resource pooling, rapid elasticity, measured service, and so forth. A cloud computing model may also come in the form of various application service models such as, for example, Software as a service (“SaaS”), Platform as a service (“PaaS”), and Infrastructure as a service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A server computing system comprising:
one or more processors; and
one or more computer-readable media having thereon computer-executable instructions that are structured such that, when executed by the one or more processors, cause the server computing system to perform a method for aiding preview providers providing previews of uniform resource locators to client computing systems in which the uniform resource locators are represented, the method comprising:
determining that a uniform resource locator is represented in a client computing system;
based on a structure of the uniform resource locator, selecting a preview provider from amongst a plurality of preview providers; and
in response to the selection of the preview provider based on the structure of the uniform resource locator, facilitating communication between the client computing system in which the uniform resource locator is represented and the preview provider that was selected based on the structure of the uniform resource locator, so that the preview provider that was selected based on the structure of the uniform resource locator can provide a preview corresponding to the uniform resource locator to the client computing system in which the uniform resource locator is represented.

2. The server computing system in accordance with claim 1, the uniform resource locator being a first uniform resource locator, and the preview being a first preview, the method further comprising:
determining that a second uniform resource locator is represented in a client computing system;
based on a structure of the second uniform resource locator, selecting a preview provider from amongst a plurality of preview providers; and
in response to the selection of the preview provider based on the structure of the second uniform resource locator, facilitating communication between the client computing system in which the second uniform resource locator is represented and the preview provider that was selected based on the structure of the second uniform resource locator, so that the preview provider that was selected based on the structure of the second uniform resource locator can provide a preview corresponding to the second uniform resource locator to the client computing system in which the second uniform resource locator is represented.

3. The server computing system in accordance with claim 2, the preview provider that was selected based on the structure of the second uniform resource locator being different than the preview provider that was selected based on the structure of the first uniform resource locator.

4. The server computing system in accordance with claim 2, the client computing system in which the second uniform resource locator is represented being different than the client computing system in which the first uniform resource locator is represented.

5. The server computing system in accordance with claim 1, the preview comprising a control that a user of the client computing system may interface with.

6. The server computing system in accordance with claim 5, the control being a sign-in control that the user may interface with in order to sign into a resource corresponding to the uniform resource locator.

7. The server computing system in accordance with claim 5, the control being a purchase control that the user may interface with in order to use a resource corresponding to the uniform resource locator to make a purchase.

8. The server computing system in accordance with claim 5, the control being a state change control that the user may interface with in order to use to change a state of a resource corresponding to the uniform resource locator.

9. The server computing system in accordance with claim 1, the preview corresponding to the uniform resource locator being a first preview corresponding to the uniform resource locator, the method further comprising:
determining that a user has interfaced with a control within the first preview corresponding to the uniform resource locator; and
in response to the determination that the user has interfaced with the control within the first preview corresponding to the uniform resource locator, facilitating communication between the client computing system in which the uniform resource locator is represented and the preview provider that was selected based on the structure of the uniform resource locator, so that the preview provider that was selected based on the structure of the uniform resource locator can provide a second preview corresponding to the uniform resource locator to the client computing system in which the uniform resource locator is represented.

10. The server computing system in accordance with claim 9, the control within the first preview corresponding to the uniform resource locator comprising a sign-in control for signing into a resource corresponding to the uniform resource locator, the second preview corresponding to the uniform resource locator comprising content accessible to the user only after signing into the resource.

11. The server computing system in accordance with claim 1, the selecting of the preview provider from amongst the plurality of preview providers being performed by comparing the uniform resource locator against mappings of uniform resource locator wpatterns and corresponding preview providers of the plurality of preview providers.

12. The server computing system in accordance with claim 1, the facilitating of the communication between the client computing system in which the uniform resource locator is represented and the preview provider that was selected based on the structure of the uniform resource locator comprising:
requesting that the preview provider provide a preview corresponding to the uniform resource locator; and
in response to receiving the requested preview from the preview provider, providing the preview to the client computing system for rendering of the preview corresponding to the uniform resource locator.

13. The server computing system in accordance with claim 1, the facilitating of the communication between the client computing system in which the uniform resource locator is represented and the preview provider that was selected based on the structure of the uniform resource locator comprising:
determining that a user of the client computing system has not consented to association with the preview provider that was selected based on the structure of the uniform resource locator; and
in response to determining that the user of the client computing system has not consented to the association, communicating with the client computing system thereby acquiring consent of the user to the association with the preview provider.

14. The server computing system in accordance with claim 1, wherein the computer-executable instructions are further structured such that, when executed by the one or more processors, cause the computing system to:
generate a preview based on a pre-defined template; and
if the user of the client computing system does not consent to the association with the preview provider, providing the preview based on the pre-defined template to the client computing system in which the uniform resource locator is represented.

15. The server computing system in accordance with claim 1, wherein the computer-executable instructions are further structured such that, when executed by the one or more processors, cause the computing system to:
generate a preview based on a pre-defined template; and
if there is not a preview provider selected based on the structure of the uniform resource locator, providing the preview based on the pre-defined template to the client computing system in which the uniform resource locator is represented.

16. The server computing system in accordance with claim 1, wherein the computer-executable instructions are further structured such that, when executed by the one or more processors, cause the computing system to:
generate a preview based on a pre-defined template; and
prior to the preview provided by the selected preview provider being provided to the client computing system, providing the preview based on the pre-defined template to the client computing system.

17. A method for a server computing system aiding preview providers in providing previews of uniform resource locators to client computing systems in which the uniform resource locators are represented, the method comprising:
determining that a uniform resource locator is represented in a client computing system;
based on a structure of the uniform resource locator, selecting a preview provider from amongst a plurality of preview providers; and
in response to the selection of the preview provider based on the structure of the uniform resource locator, facilitating communication between the client computing system in which the uniform resource locator is represented and the preview provider that was selected based on the structure of the uniform resource locator, so that the preview provider that was selected based on the structure of the uniform resource locator can provide a preview corresponding to the uniform resource locator to the client computing system in which the uniform resource locator is represented.

18. The method in accordance with claim 17, the preview corresponding to the uniform resource locator being a first preview corresponding to the uniform resource locator, the method further comprising:
determining that a user has interfaced with a control within the first preview corresponding to the uniform resource locator; and
in response to the determination that the user has interfaced with the control within the first preview corresponding to the uniform resource locator, facilitating communication between the client computing system in which the uniform resource locator is represented and the preview provider that was selected based on the structure of the uniform resource locator, so that the preview provider that was selected based on the structure of the uniform resource locator can provide a second preview corresponding to the uniform resource locator to the client computing system in which the uniform resource locator is represented.

19. The method in accordance with claim 17, the facilitating of the communication between the client computing system in which the uniform resource locator is represented and the preview provider that was selected based on the structure of the uniform resource locator comprising:
requesting that the preview provider provide a preview corresponding to the uniform resource locator; and
in response to receiving the requested preview from the preview provider, providing the preview to the client computing system for rendering of the preview corresponding to the uniform resource locator.

20. A computer program product comprising one or more computer-readable storage media having thereon computer-executable instructions that are structured such that, when executed by one or more processors of a server computing system, cause the server computing system to perform a method for a server computing system aiding preview providers in providing previews of uniform resource locators to client computing systems in which the uniform resource locators are represented, the method comprising:
determining that a uniform resource locator is represented in a client computing system;
based on a structure of the uniform resource locator, selecting a preview provider from amongst a plurality of preview providers; and
in response to the selection of the preview provider based on the structure of the uniform resource locator, facilitating communication between the client computing system in which the uniform resource locator is represented and the preview provider that was selected based on the structure of the uniform resource locator, so that the preview provider that was selected based on the structure of the uniform resource locator can provide a preview corresponding to the uniform resource locator to the client computing system in which the uniform resource locator is represented.
